(19) United States
(12) Patent Application Publication
(10) Pub. No.: US 2005/0212866 A1
(43) Pub. Date: Sep. 29, 2005

(54) Ink-jet head

(76) Inventors: Masaaki Furuya, Kanagawa-ken (JP); Kenichi Ooshiro, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/086,227

(22) Filed: Mar. 23, 2005

(30) Foreign Application Priority Data
Mar. 23, 2004 (JP) 2004-085557

(51) Int. Cl. B41J 2/045

(52) U.S. Cl. 347/70

(57) ABSTRACT

An ink-jet head. A first plate has a back face and contains an aperture to discharge an ink. A second plate having a top face and a back face, contains a first ink channel penetrating the second plate and communicating with the aperture. The top face of the second plate is detachably contacted with the back face of the first plate. A diaphragm plate having a top face and a back face, is detachably mounted in contact with the back face of the second plate. A piezoelectric element is attached to the back face of the diaphragm plate and operable upon energization to change a volume of the first ink channel.

### CROSS REFERENCE TO RELATED APPLICATION

This application is based upon and claims the benefit of priority from the prior Japanese Patent Application No. 2004-085557 filed on Mar. 23, 2004, the entire contents of which are incorporated herein by reference.

### BACKGROUND

1. Technical Field

This invention relates to an ink-jet head, in particular to an ink-jet head which discharges a droplet using a piezoelectric element.

2. Description of the Related Art

An ink-jet applying method is beginning to be used to form a color filter of a liquid crystal display or an emitting layer of an organic electro luminescent (EL) display. The ink-jet applying method is a method to apply a liquid to a flat surface in a minute amount to form a pattern of the color filter or the like.

FIG. 5 shows a conventional structure of an ink-jet head 100 of an ink-jet application apparatus used for such an industrial use. The structure is shown in Japanese Patent No. 3389987.

As shown in FIG. 5, an ink-jet head 100 is provided with a nozzle plate 101 in which plural nozzle apertures 102 are formed. Ink-jet head 100 is also provided with a nozzle plate 103 and a diaphragm 106. Ink channels 104 are formed in nozzle plate 103 to suck in an ink and discharge the sucked ink through apertures 102. Diaphragm plate 106 varies the pressure inside ink channels 104. Ink-jet head 100 further includes piezoelectric elements 111 and a base part 109 on which base part 109 is bonded. An opening 108 into which piezoelectric element 111 are inserted is formed in base part 109. Elements 101, 103, 106, 109, and 110 are vertically stacked.

Ink flow channels 105 communicating with each ink channel 104 are further formed in nozzle plate 103. Ink supplying holes 107 are formed in both diaphragm 106 and base part 109, to supply ink to ink flow channels 105.

An operation of ink-jet head 100 is explained next. Applying a voltage to a piezoelectric element 111 deforms diaphragm 106. The deformation of diaphragm 106 causes a variation of volume of ink channel 104. Such variation of volume depends on the applied voltage. The variation of volume of ink channel 104 makes ink channel 104 suck in ink from ink flow channel 105 and discharge the sucked ink through nozzle aperture 102.

It is desirable for the pitch between nozzle apertures 102 of ink-jet head 100 to be as small as possible in order to form a fine pattern. For such purpose, one way is to fabricate piezoelectric element 111 as thin as possible in order to shorten the clearance between ink channels 104. In addition, in order to fabricate ink channels 104 and ink flow channels 105, an etching method, which is normally used for manufacturing a semiconductor device, may be used.

However, a party wall extends away from ink channels 104 is needed to independently discharge a droplet. The party wall must have a certain level of thickness so as not to transmit an applied pressure to adjacent ink channel 104.

Therefore, a certain amount of separation distance between nozzle apertures 102 is necessary. Accordingly, as shown in FIG. 5, two lines of piezo electric elements 111 and nozzle apertures 102 corresponding thereto, are provided. As shown in FIG. 6, each nozzle aperture 102 of one line is formed so as to be located at a midpoint between nozzle apertures 102 of the other line. Thereby, it is possible to apply droplets with an interval (a), which is a half of the separation distance between nozzle apertures 102.

Forming two or more lines of nozzle apertures 102 and moving a target (e.g., paper), to which droplets are to be applied, in a perpendicular direction to the lines of nozzle apertures 102, enables a fine pattern. Moving the target at a low speed is another way to form a fine pattern. When there is sufficient time for application, moving ink-jet head 100 relative to a target bit by bit enables forming a fine pattern which is finer than the pitch of nozzle apertures 102.

When the target is paper, an ink-jet application apparatus controls the timing of discharge, based on positions of nozzle apertures 102. When an ink-jet application apparatus needs to form a pattern at a specific position on the target, it controls the discharge timing based on a feed speed of the target.

As shown in FIG. 7, ink-jet head 100 is positioned at an angle with respect to the target feed direction, thereby adjusting the pitch of a pattern in a direction (Y-direction) perpendicular to the feed direction (X-direction).

However, when ink-jet head 100 is positioned at an angle, ink-jet head 100 must control the discharge timing in the X-direction, because positions of nozzle apertures are not the same as each other in the X-direction. Further, only one line of nozzle apertures is suitable for angling because when an ink-jet head having two lines of nozzle apertures such as an ink-jet head shown in FIG. 7 is angled, nozzle apertures of one line are not aligned, in the Y-direction, to an exact center position between nozzle apertures of the other line.

As a result, a preferable way in order to form a pattern of droplets which has a small pitch is angling of an ink-jet head having only one line of nozzle apertures in addition to shortening a clearance between nozzle apertures as much as possible.

Another conventional structure is shown in FIG. 8 and FIG. 9 where a single line of nozzle apertures which are connected to ink flow channels 104 alternately extending in a direction perpendicular to a direction of the single line, is known. This structure makes it possible to form a pattern of a pitch (d) which is smaller than that of a pattern formed by an ink-jet head having two lines of nozzle apertures. However, this structure has difficulty in cleaning up the flow path in the structure, which washing is necessary to stably discharge droplets.

The ink-jet head shown in FIG. 8 can freely adjust a pitch (d) by adjusting an angle with respect to the feed direction. However, since an internal structure of a flow path is not straight, it is difficult to remove a bubble or solidified ink remaining in the flow path.

In particular, since ink flow channel 104 has a complicated structure, an ultrasonic wave, which is effective to remove a residue, cannot directly reach a wall of ink flow channel 104. In order to remove such a residue, it is necessary to employ running-water cleaning methods using a liquid to dissolve the residue such as an organic solvent is necessary instead of using an ultrasonic-cleaning which deteriorates washing ability where an ultrasonic wave cannot directly reach.

### SUMMARY

Consistent with the invention, there is provided an ink-jet head. The ink-jet head comprises a first plate having a back face and containing an aperture to discharge an ink; and a second plate having a top face and a back face, the second plate containing a first ink channel penetrating the second plate and communicating with the aperture, the top face of the second plate being detachably contacting with the back face of the first plate. The ink-jet head also comprises a diaphragm plate having a top face and a back face, the diaphragm top face detachably mounted in contact with the back face of the second plate, and a piezoelectric element attached to the back face of the diaphragm plate and operable upon energization to change a volume of the first ink channel.

### BRIEF DESCRIPTION OF THE DRAWING

FIG. 1 is an oblique view of a disassembled ink-jet head, consistent with the invention.

FIG. 2 is a sectional view of the ink-jet head of FIG. 1.

FIG. 3 is a sectional view of the disassembled ink-jet head shown in FIG. 1.

FIG. 4 is a sectional view of a second disassembled ink-jet head, consistent with the invention.

FIG. 5 is an oblique view of a disassembled ink-jet head, consistent with the prior art.

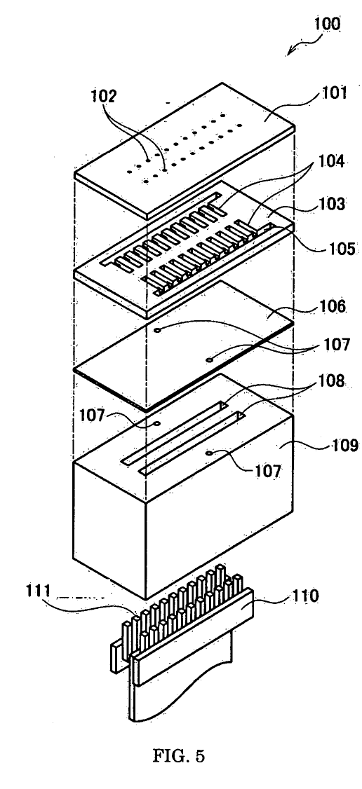

FIG. 6 is a plan view of a nozzle plate of the ink-jet head shown in FIG. 5.

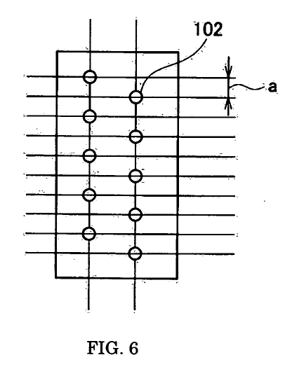

FIG. 7 is a plan view of the nozzle plate of FIG. 5 which is angled with respect to a feed direction.

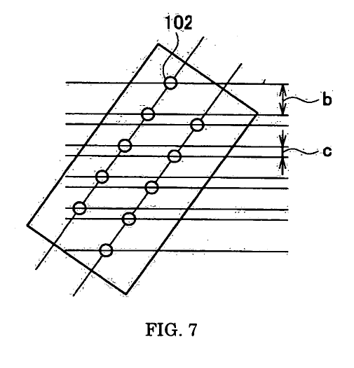

FIG. 8 is a plan view of a nozzle plate, consistent with the prior art, having apertures in line.

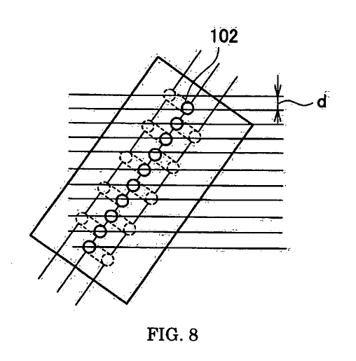

FIG. 9 is an oblique view of an ink-jet head having the another nozzle plate consistent with the prior art.

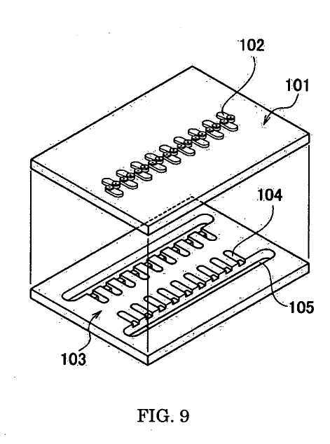

### DETAILED DESCRIPTION

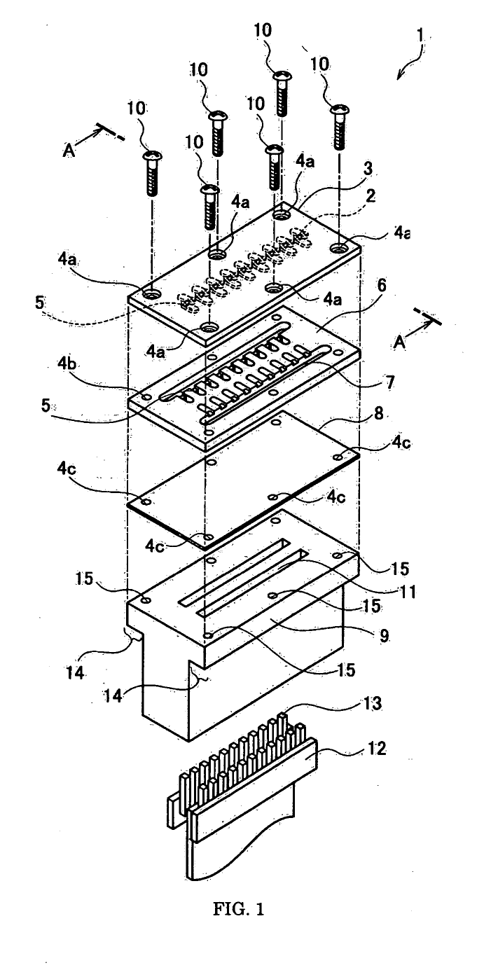

One embodiment in consistent with the present invention is described next with respect to FIGS. 1 to 3.

FIG. 1 shows an oblique view of a disassembled ink-jet head 1. Ink-jet head 1 is provided with a nozzle plate 3 (a first plate), an ink chamber plate 6 (a second plate), a diaphragm plate 8, a base part 9, and a piezoelectric element part 12.

Plural nozzle apertures 2 (apertures) formed in nozzle plate 3 are arranged in line with each clearance.

Ink channels 5a (first ink channels) to supply ink to nozzle apertures 2 are formed in ink chamber plate 6, penetrating ink chamber plate 6. Ink channels 5a respectively suck in ink and supply the sucked ink to nozzle apertures 2.

Base part 9 has two openings 11 into which piezoelectric elements 13 of piezoelectric element part 12 are inserted. The inserted piezoelectric element 13 contacts a back surface of diaphragm plate 8, and applies a pressure to change the volume and pressure inside ink channel 5a by deforming diaphragm plate 8. These elements 3, 6, 8, 9, and 12 are stacked together to constitute ink-jet head 1.

Ink channels 5b (second ink channels) are formed in nozzle plate 3. Ink channels 5b do not completely penetrate nozzle plate 3 but have an opening to a top face of ink chamber plate 6. Each second ink channel 5b communicates with both a corresponding nozzle aperture 2 and a corresponding first ink channel 5a so that each first ink channel 5a supplies ink to a nozzle aperture 2 via first ink channel 5b. First and second ink channels 5a and 5b together constitute ink channels 5.

As shown in FIG. 1, first ink channels 5a alternately extend in a direction perpendicular to a direction of the line of nozzle apertures 2.

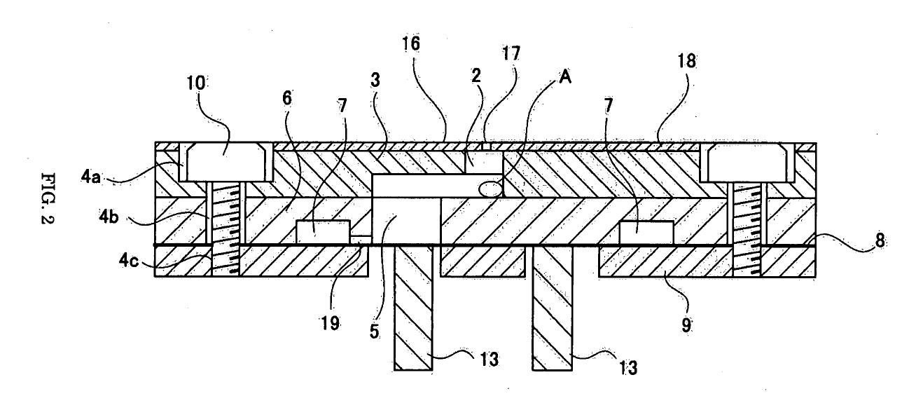

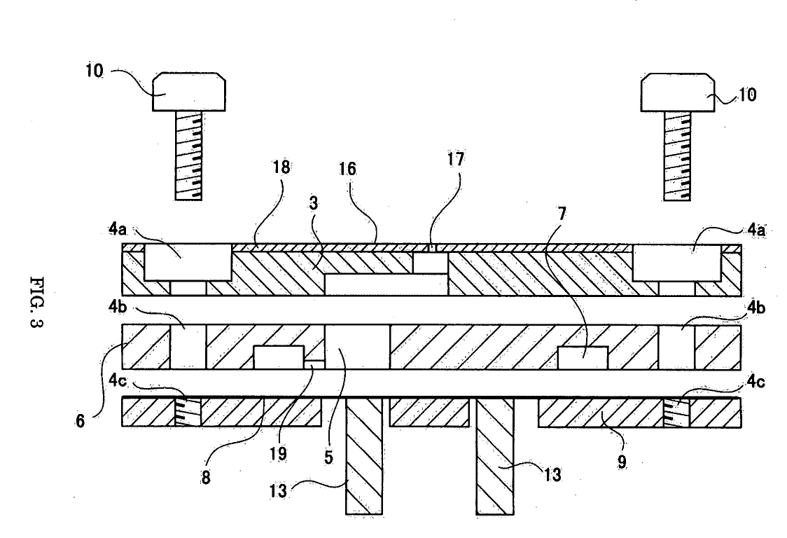

Two elongated ink flow channels 7 are formed in ink chamber plate 6 to supply an ink to first ink channel 5a through a groove 19 (FIGS. 2 and 3). Ink flow channels 7 and grooves 19 do not penetrate ink chamber plate 6 but have an opening to diaphragm plate 8. Two ink flow channels 7 are formed in parallel with each other. One ink flow channel 7 communicates with one row of ink channels 5a, and the other ink flow channel 7 communicates with the other row of ink channels 5a, through grooves 19. Diaphragm plate 8 and base part 9 respectively have a through-hole (not shown) communicating with ink flow channel 7. Ink is supplied to ink flow channel 7 through the through-holes.

Six through-holes 4a, with counter boring to receive setscrews 10, are bored at a periphery of nozzle plate 3. Through-holes 4b and 4c are formed in ink chamber plate 6 and diaphragm plate 6, respectively, at positions corresponding to through-holes 4a.

Diaphragm plate 8 is made from an elastic material and is positioned between ink chamber plate 6 and base part 9. Setscrews 10 are inserted into screw holes 4a to fix the relative positions of nozzle plate 3, ink chamber plate 6, diaphragm plate 8, and base part 9. Instead of using a screw, an adhesive agent can be used to fix there relative positions. Threaded holes 15 are formed in protruding parts 14 of base part 9. Each setscrew 10 passing through through-holes 4a, 4b and 4c is threaded into a respective hole 15 so as to secure nozzle plate 3, ink chamber plate 6, and diaphragm plate 8.

Nozzle plate 3 and ink chamber plate 6 may be made of sintered ceramic or metal. Mating faces of those plates 3 and 6, the top and bottom faces of ink chamber plate 6 and nozzle plate 3, are preferably buff-finished in order to reduce surface-roughness.

Two openings 11 through which piezoelectric elements 13 are inserted are formed in parallel with each other in base part 9. As shown in FIG. 1, there are two lines of piezoelectric elements 13. Piezoelectric elements 13 of one line are offset with respect to corresponding elements 13 of the other line so as to be aligned between the corresponding elements in a longitudinal direction. Thus, each piezoelectric element 13 can change a volume of corresponding ink channel 5. Top faces of piezoelectric elements 13 are bonded on a back face of diaphragm plate 8 with an adhesive agent. Each piezoelectric element 13 may be activated by applying a voltage through a wire (not shown) connected to each piezoelectric element 13. Appling a voltage to piezoelectric elements 13 pushes and pulls diaphragm plate 8.

FIG. 2 is a cross sectional view of a cross section A-A (which is shown in FIG. 1) of an assembled ink-jet head 1. A part of diaphragm plate 8 where a top surface of piezoelectric element 13 contacts, constitutes a part of a wall of ink channel 5 which is formed in nozzle plate 3 and ink chamber plate 6.

An orifice plate 16 is bonded on a top surface of nozzle plate 3 using an adhesive agent or diffusion bonding. Orifices 17, communicating with nozzle apertures 2, are formed in orifice plate 16. Further, through-holes corresponding to screw holes 4a are also formed in orifice plate 16.

A surface of diaphragm plate 8 may also be highly finished to reduce a surface roughness, as with nozzle plate 3 and ink chamber plate 6. Thus, nozzle plate 3, ink chamber plate 6, and diaphragm plate 8 closely contact each other, with minimum space between them. However, they can be disassembled by loosening setscrews 10, which integrate nozzle plate 3, ink chamber plate 6, and diaphragm plate 8. In other words, a top face of ink chamber plate 6 detachably contacts a back face of nozzle plate 3, and a top face of diaphragm plate 8 detachably contacts a back face of ink chamber plate 6.

The interface between nozzle plate 3 and ink chamber plate 6 is in parallel to the top surface of nozzle plate 3, including the end faces of nozzle apertures 2. Consequently, a distance between the each end face of nozzle aperture 2 and the interface is uniform so that an amount of a droplet discharged from each nozzle aperture 2 can be also uniform.

When an ink application apparatus has plural ink-jet heads, the ink application apparatus must control each ink-jet head so as to uniformly discharge a droplet. To compensate for a dispersion between ink-jet heads, controlling a distance between each ink-jet head and a subject is one way. However, it is quite complicated. However, by using ink-jet heads 1, a distance between the each end face of nozzle aperture 2 and the interface can be made uniform among ink-jet heads 1 so that each ink-jet head 1 can discharge a droplet having almost same amount of ink, without requiring complicated distance control.

The operation of ink-jet head 1 is explained next. Applying a voltage to piezoelectric element 13 makes piezoelectric element 13 shrink. Then, the volume of the corresponding ink channel 5 enlarges, since the shrunken piezoelectric element 13a pulls the part of diaphragm plate 8 which corresponds to a wall of ink channel 5. The enlarged ink channel 5 draws ink stored in ink flow channel 7. An ink supply tank (not shown) located separated from ink-jet head 1, supplies ink to ink flow channel 7 through the through-holes (not shown).

Next, changing (reducing) the applied voltage to piezoelectric element 13 rapidly extends piezo electric 13, which extension makes the volume of the corresponding part of ink channel 5 shrink rapidly. Ink inside ink channel 5 proceeds, not to groove 19, but rather to a corresponding nozzle aperture 2, since flow channel resistance of nozzle aperture 2 is smaller than that of groove 19. As a result, a droplet of ink is discharged through orifice 17 of orifice plate 16. After, removing voltage to piezoelectric element 13, ink-jet head 1 returns to its initial condition.

When using an ink including an organic material as a base material, the ink, which is subject to dry-out, may become solidified around the front edge of nozzle aperture 2, fouling the ink-jet head. In such a case, ink-jet head 1 needs to be washed so as to remove the fouling.

As shown in FIG. 3, unscrewing setscrew 10 easily disassemblies ink-jet head 1, separating nozzle plate 3, ink chamber plate 6, base part 9, and diaphragm plate 8, facilitating a cleaning operation. Moreover, inner surfaces of ink channels 5a and 5b are perpendicular to the mating faces so that waves generated in ultrasonic-cleaning or MHz-cleaning can directly reach almost all the inner surface of them.

In conventional ink-jet heads, solidified ink on an inner wall of channels can be difficult to remove. However, with ink-jet head 1, solidified ink can be removed easily. Further, the solidified ink can be visually observed or analyzed using a micro scope. Such an analyze can contribute to improve a washing efficiency.

Since ultrasonic-cleaning may generate a cavitation which may damage a surface of an ink-jet head 1, ink-jet head 1 can be washed using minimum power and time as less as possible.

In addition, disassembling cramped nozzle plate 3, ink chamber plate 6 and diaphragm plate 8, eliminates a blind corner of a flow path of ink. Thus, an area, e.g., a bent part of a flow path, which is difficult to wash in a conventional ink-jet head, can be washed. For example, a solidified ink accumulated around an area A (FIG. 2) can be removed. While, a conventional ink-jet head has a nozzle plate and a ink chamber plate which are integrated using adhesive agent or such, a solidified ink accumulated around a blind corner cannot be easily removed.

Next, an evaluation of discharge characteristics is experimented.

In this experiment, an ink-jet head having 64 nozzle apertures in line, and two lines of 32 ink channels which alternately connected to the nozzle apertures, are used.

In order to amplify an effect on an adjacent ink channel, only one line of 32 ink channels are pressed by piezoelectric elements. 32 nozzle apertures discharge droplets toward a measuring plate. The degree of displacement between a target position and an actual impact position, is measured. Further, a diameter of a droplet which hits the plate is also measured. The diameter of the droplet has a relation to an amount of a discharged droplet so that a dispersion of an amount can be evaluated.

The average of the displacement between the target position and the impact position, is about 2.5% of a pitch of nozzle apertures. The maximum displacement of that is 3.5% of the pitch. As to the diameter of the droplet, the maximum difference between the average diameter of all the droplets and the diameter of each droplet is within 3% of the average diameter. Therefore, the discharge characteristics of the ink-jet head in consistent with the present invention is by no means inferior to an conventional one.

As a result, the ink-jet head can perform as well as the conventional ink-jet head even though the ink channel can be disassembled to two parts, i.e., nozzle plate 3 and ink chamber plate 6.

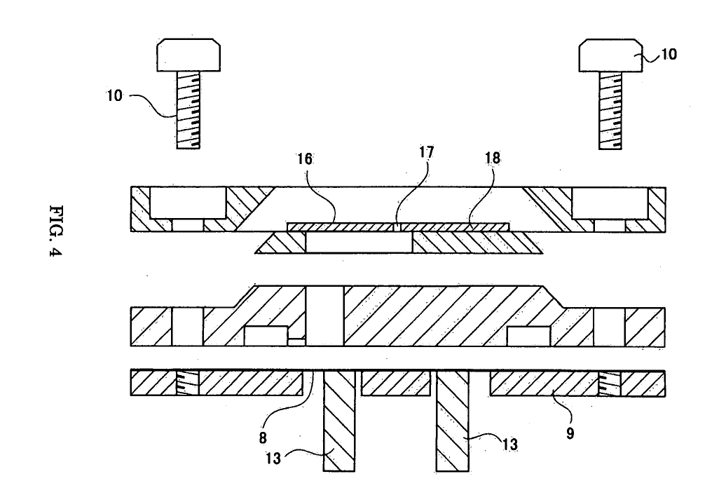

A second embodiment in consistent with the present invention is explained next with reference to FIG. 4. FIG. 4 shows a sectional view of a disassembled ink-jet head 30. The structure of ink channel 5 and ink flow channel 7 are the same as that of ink-jet head 1, so the detailed description is omitted. The difference between this embodiment and the first one is to use another frame part 31 to receive setscrew 10. Even though it is necessary to closely contact between nozzle plate 3, inc storage plate 6 and base part 9 to efficiently transmit a pressure applied by piezoelectric element 13, a part which receives setscrew 10 does not necessarily closely contact with ink chamber plate 6. Therefore, using a frame part 31, a sufficient depth of counter boring to receive setscrew 10 can be formed.

Numerous modifications of the present invention are possible in light of the above teachings. It is therefore to be understood that, within the scope of the appended claims, the present invention can be practiced in a manner other than as specifically described herein. When a certain effect can be accomplished without some elements shown in this embodiment, such elements can be omitted.

In this embodiment, orifice plate 16 and nozzle plate 3 are made of stainless plate. However, another metal such as Tungsten or Nickel plated metal may be used. Resin such as polyimide resin may be used. Ink-jet head 1 or 30 may discharge not only an ink for printing a paper but also an ink to form a color filter of a liquid crystal display or an emitting layer of an organic electro luminescent (EL) display or the like.

Orifice 16 may be bonded on nozzle plate 3 using diffusion bonding or an adhesive agent. In using an adhesive agent, it is possible to confirm whether there is an overflowed agent by disassembling ink-jet head 1 or 30. It is even possible to remove the overflowed agent. It is also possible to use three or more lines of piezoelectric elements by adding another nozzle plate.

1. An ink-jet head, comprising:
a first plate having a back face and containing an aperture to discharge an ink;
a second plate having a top face and a back face, the second plate containing a first ink channel penetrating the second plate and communicating with the aperture, the top face of the second plate being detachably contacting with the back face of the first plate;
a diaphragm plate having a top face and a back face, the diaphragm top face detachably mounted in contact with the back face of the second plate; and
a piezoelectric element attached to the back face of the diaphragm plate and operable upon energization to change a volume of the first ink channel.

2. An ink-jet head according to claim 1, further comprising a base part in contact with the back face of the diaphragm plate, the base part containing a through-hole through which the piezoelectric element is inserted.

3. An ink-jet head according to claim 1, wherein:
the second plate comprises an inner wall;
the first ink channel comprises a sidewall; and
the second plate inner wall corresponding to a sidewall of the first ink channel is substantially perpendicular to the top and back faces of the second plate.

4. An ink-jet head according to claim 1, wherein the top face of the first plate is in parallel with an interface between the first and second plates.

5. An ink-jet head according to claim 1, further comprising an orifice plate in contact with a top surface of the first plate, the orifice plate containing an orifice communicating with the aperture.

6. An ink-jet head according to claim 1, wherein an inner wall of the first ink channel is made of metal.

7. An ink-jet head according to claim 1, wherein an inner wall of the first ink channel is made of ceramic.

8. An ink-jet head according to claim 1, wherein the first plate contains a second ink channel provided between the aperture and the first ink channel, and the first ink channel communicates with the aperture through the second ink channel.

9. An ink-jet head according to claim 1, wherein the first plate contains plural apertures to discharge an ink and the second plate contains plural first ink channels penetrating the second plate and communicating with the apertures.

10. An ink-jet head according to claim 2, further comprising a screw penetrating and securing the first, second and diaphragm plates by engaging with a female screw formed in the base part.

11. An ink-jet head according to claim 8, wherein the second ink channel is an indentation open to the top face of the second plate.

12. An ink-jet head according to claim 9, wherein the second plate contains an ink flow channel communicating with the plural first ink channels.

13. An ink-jet head according to claim 9, wherein the plural apertures are arranged in line.

14. An ink-jet head according to claim 12, wherein the ink flow channel is an indentation open to the top face of the diaphragm plate.

15. An ink-jet head according to claim 13, wherein the plural first ink channels alternately extend to a direction perpendicular to a direction of the line of the apertures.
